(19) United States
(12) Patent Application Publication
(10) Pub. No.: US 2018/0344089 A1
(43) Pub. Date: Dec. 6, 2018

(54) FOOD PROCESSOR

(71) Applicant: TAYLOR PRECISION PRODUCTS, INC., Seattle, WA (US)

(72) Inventor: Matt KRUS, Seattle, WA (US)

(21) Appl. No.: 15/987,628

(22) Filed: May 23, 2018

Related U.S. Application Data
(60) Provisional application No. 62/514,665, filed on Jun. 2, 2017.

(51) Int. Cl. A47J 43/046; A47J 43/07; B01F 15/00; B01F 13/00; B01F 13/10

(52) U.S. Cl. CPC A47J 43/046; A47J 43/0722; B01F 15/00987; B01F 15/00506; B01F 2015/00084; B01F 13/1044; B01F 2013/108; B01F 2215/0026; B01F 13/002

(57) ABSTRACT

A food processor can include a strainer, a sealing gasket, a blade assembly, and a lid. The food processor can be used in combination with a container such as a bowl or a flask, and in combination with an actuator. The actuator can be operated to actuate the blade assembly to rotate within the strainer to chop food items held therein, which can fall through the strainer into the container when they have been sufficiently chopped.

### BACKGROUND

### Technical Field

The present disclosure is directed generally to systems for processing food, and more specifically to systems for cutting or chopping food items such as nuts into smaller pieces.

### Description of the Related Art

Hand-held food processors are known and are widely available. Many food processors include an actuator, such as a hand-powered or electrically-powered actuator, which is coupled to a spindle and thereby to one or more cutting instruments such as blades. The actuator can be operated to actuate the spindle and the cutting instruments to rotate and thereby to cut or chop food items. One example of such a food processor is a vegetable chopper commercially available from Taylor Precision Products, Inc., under the brand name VEGGICHOP. Another example is described in U.S. Pat. No. 7,264,189, which is hereby incorporated herein by reference, in its entirety.

### BRIEF SUMMARY

A food processor may be summarized as comprising: a strainer including a bottom wall having a plurality of holes and a side wall extending upward from an outer periphery of the bottom wall, the side wall having an opening and an outer surface; and a sealing gasket extending circumferentially around the outer surface of the side wall, the sealing gasket having an inner surface sealed to the outer surface of the side wall of the strainer, the sealing gasket having a pull-tab extending through the opening in the side wall of the strainer. The strainer may include a pin extending upward from a center portion of the bottom wall, and the food processor may further comprise a blade assembly having an indentation that extends upward into the blade assembly at a center portion of a bottom end of the blade assembly, the indentation having a shape corresponding to a shape of the pin. A bottom portion of the side wall of the strainer may include a plurality of protrusions spaced equally apart from one another about a central axis of the strainer, the protrusions extending radially inward into an interior of the strainer.

The side wall of the strainer may include a bottom, vertical portion, an intermediate, conical portion, and a top, vertical portion. A bottom end of the intermediate, conical portion may be coupled directly to a top end of the bottom, vertical portion and a bottom end of the top, vertical portion may be coupled directly to a top end of the intermediate, conical portion. The bottom, vertical portion may have a first inner diameter and the top, vertical portion may have a second inner diameter that is larger than the first inner diameter.

The sealing gasket may include a bottom conical portion and a top, cylindrical portion. A bottom end of the top, cylindrical portion of the sealing gasket may be coupled directly to a top end of the bottom, conical portion. A bottom end of the bottom, conical portion may have a third inner diameter and the top, cylindrical portion of the sealing gasket may have a fourth inner diameter that is larger than the third inner diameter. An inner surface of the bottom, conical portion of the sealing gasket may be sealed against an outer surface of the intermediate, conical portion of the side wall of the strainer. An inner surface of the top, cylindrical portion of the sealing gasket may be sealed against an outer surface of the top, cylindrical portion of the side wall of the strainer.

A method of processing food may be summarized as comprising: coupling a gasket to a strainer so that a seal is formed between an inner surface of the gasket and an outer surface of the strainer and so that a pull-tab of the gasket extends through an opening in a side wall of the strainer into an interior of the strainer; positioning the strainer and the seal on top of a container; positioning a blade assembly inside the strainer; positioning nuts inside the strainer around the blade assembly; positioning an actuator on top of the strainer and the blade assembly; and operating the actuator to drive rotation of the blade assembly.

The method may further comprise pulling the pull tab through the opening toward the interior of the strainer. Positioning the nuts inside the strainer may include positioning between ¼ cup and ½ cup of nuts inside the strainer. The actuator may be hand-powered. Operating the actuator may include operating the actuator to drive intermittent rotation of the blade assembly. The strainer may include a plurality of holes sized to allow ⅛ to ¼ of a peanut to fall through.

### BRIEF DESCRIPTION OF THE SEVERAL VIEWS OF THE DRAWINGS

FIG. 1 illustrates a top, perspective view of a food processor.

FIG. 2 illustrates a bottom, perspective view of a lid of the food processor of FIG. 1.

FIG. 3 illustrates a top, perspective view of the food processor of FIG. 1 with the lid of FIG. 2 removed.

FIG. 4 illustrates a top, perspective view of a strainer of the food processor of FIG. 1.

FIG. 5 illustrates a bottom, perspective view of the strainer of FIG. 4.

FIG. 6 illustrates a top, perspective view of a seal of the food processor of FIG. 1.

FIG. 7 illustrates a bottom, perspective view of the seal of FIG. 6.

FIG. 8 illustrates a top, perspective view of a blade assembly of the food processor of FIG. 1.

FIG. 9 illustrates a bottom, perspective view of the blade assembly of FIG. 8.

FIG. 10 illustrates another top, perspective view of the blade assembly of FIG. 8.

FIG. 11 illustrates a bottom, perspective view of an outer shaft of the blade assembly of FIG. 8.

FIG. 12 illustrates a top, perspective view of the blade assembly of FIG. 8 with the outer shaft of FIG. 11 removed.

FIG. 13 illustrates a top, perspective view of the blade assembly of FIG. 12 with a first blade removed.

FIG. 14 illustrates a top, perspective view of the blade assembly of FIG. 13 with a blade spacer removed.

FIG. 15 illustrates a top, perspective view of the blade assembly of FIG. 14 with a second blade removed.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with the technology have not been shown or described in detail to avoid unnecessarily obscuring descriptions of the embodiments.

As used herein, terms of relative elevation, such as “top,” “bottom,” “above,” “below,” etc., are used in accordance with their ordinary meanings, such that when a device is in use, gravity acts to pull items from the top of the device to the bottom of the device.

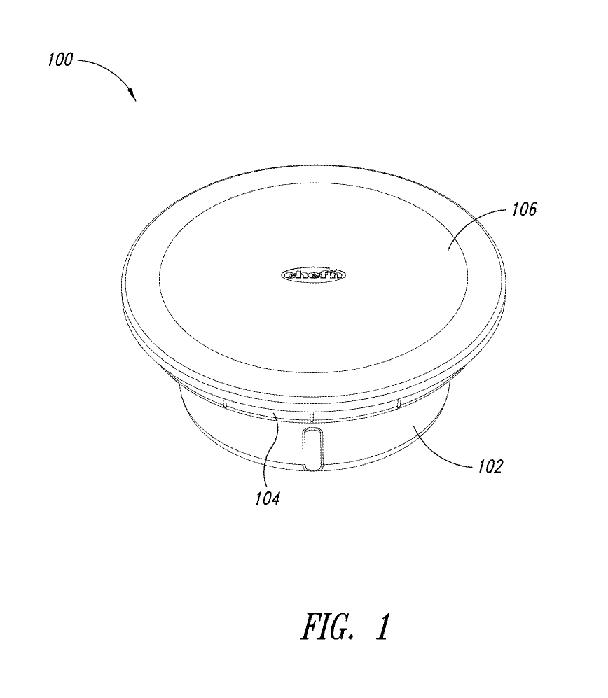

FIG. 1 illustrates a top, perspective view of a food processor 100, according to one embodiment. As illustrated in FIG. 1, the food processor 100 includes a bottom portion 102, which can be a strainer or a filter 102, or a bowl with a mesh or a plurality of holes at its bottom end. The strainer 102 can be made from a thin-walled plastic or metal material such as stainless steel, and can be 3D printed or punched and/or stamped from blanks. The food processor 100 also includes a seal 104, which can be a silicone gasket, that extends circumferentially around an outer surface of the strainer 102, and a lid 106 that sits on top of the strainer 102 when the food processor 100 is not in use.

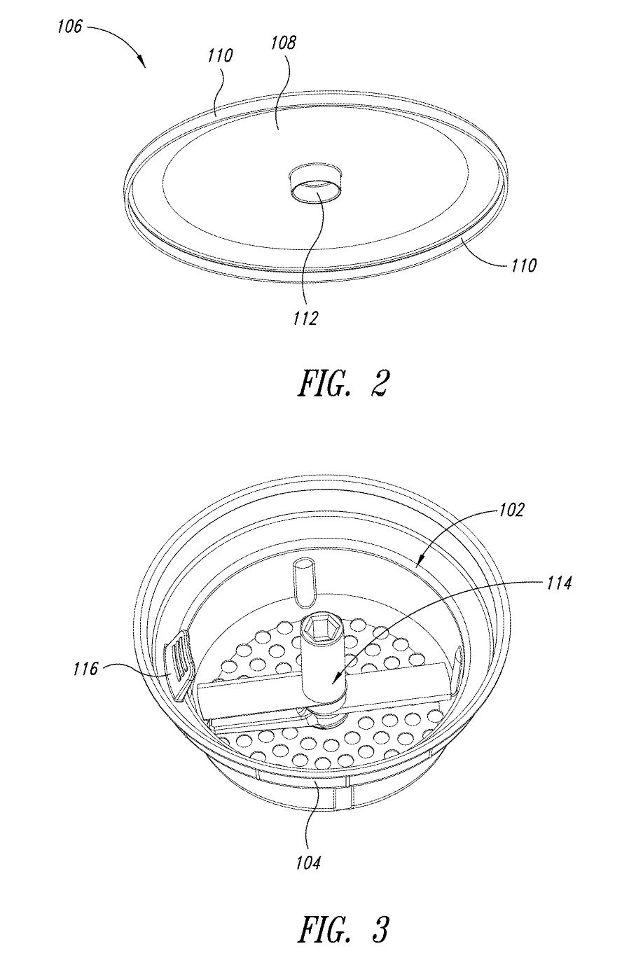

FIG. 2 illustrates a bottom, perspective view of the lid 106. As illustrated in FIG. 2, the lid 106 includes a top disk 108 that, when the lid 106 sits on the strainer 102, spans across a top end of the strainer 102. The lid 106 also includes an outer cylindrical flange 110 that extends downward from an outer peripheral edge of the disk 108, and an inner cylindrical flange 112 that extends downward from a center portion of the disk 108. When the food processor 100 is not in use, the lid 106 can be fitted onto and over the top end of the strainer 102 with an inner surface of the outer flange 110 frictionally engaged with an outer surface of the top end or rim of the strainer 102. Thus, the lid 106 can protect the components inside the food processor 100 while the food processor 100 is in storage or otherwise not in use.

FIG. 3 illustrates a top, perspective view of the food processor 100 with the lid 106 removed. As illustrated in FIG. 3, the food processor 100 includes a spindle or a blade assembly 114 within the strainer 102, which is described further elsewhere herein. FIG. 3 also illustrates that the seal 104 includes a pull-tab 116, which extends from a portion of the seal 104 that extends circumferentially around an outer surface of the strainer 102, through an opening in a side wall of the strainer 102, and to an open inner space within the strainer 102.

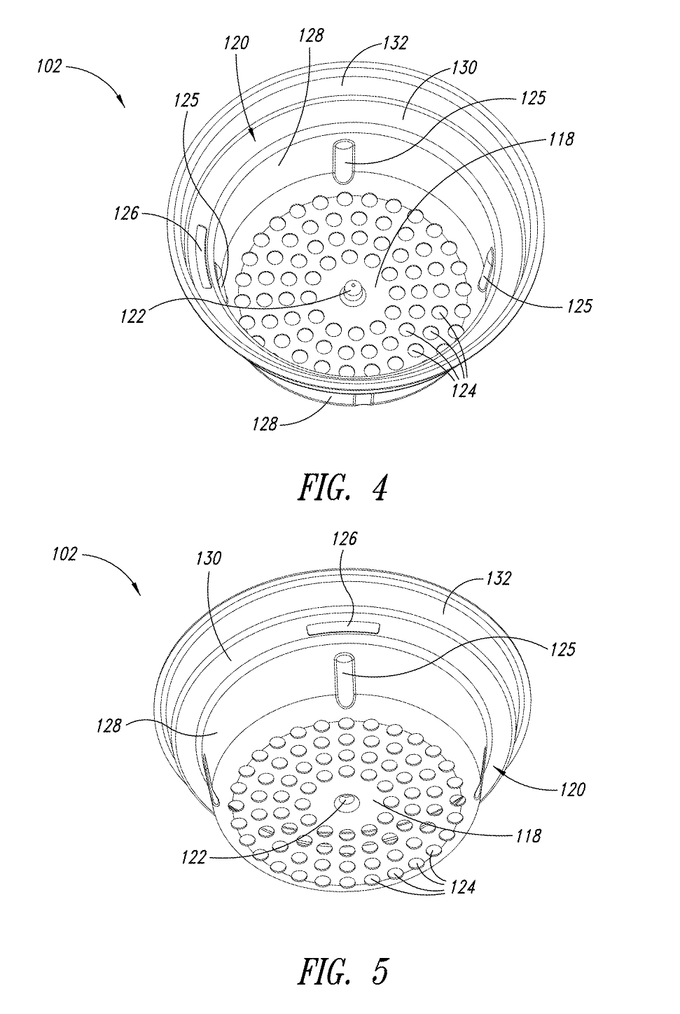

FIGS. 4 and 5 illustrate a top, perspective view and a bottom, perspective view, respectively, of the strainer 102 of the food processor 100. As illustrated in FIGS. 4 and 5, the strainer 102 includes a circular bottom wall 118 and a circumferential and generally cylindrical side wall 120 that extends upward from an outer peripheral edge of the bottom wall 118, such that the strainer 102 is generally bowl-shaped. As also illustrated in FIGS. 4 and 5, the bottom wall 118 includes a protrusion, or knob, or pin 122, which extends upward from the center of the bottom wall 118, and a plurality of apertures, openings, or holes 124 surrounding the pin 122, which extend through the bottom wall 118. As examples, the bottom wall 118 can include a plurality of holes, or a mesh screen, or between 10 and 200, between 20 and 150, between 30 and 120, between 50 and 100, between 70 and 80, or about 80 holes 124. As further examples, the holes 124 can be circular with diameters between 2 and 20, between 3 and 15, between 4 and 10, between 5 and 8, about 6, or about 6.2 mm, or with diameters sufficient to allow about ⅛ to about ¼ of a peanut or other specified nut to fall through.

As also illustrated in FIGS. 4 and 5, the side wall 120 of the strainer 102 includes a bottom, generally vertical portion 128, which has a first inner diameter, and which is coupled at a bottom end thereof directly to the outer periphery of the bottom wall 118. The side wall 120 also includes an intermediate, generally conical portion 130, which is coupled at a bottom end thereof directly to a top end of the bottom portion 128. The side wall 120 also includes a top, generally vertical portion 132, which has a second inner diameter larger than the first inner diameter, and which is coupled at a bottom end thereof directly to a top end of the intermediate portion 130. FIGS. 4 and 5 also illustrate that the bottom portion 128 of the side wall 120 includes inward-facing bumps or protrusions 125, such as four protrusions 125 spaced equally apart from one another by about 90° about a central axis of the strainer 102, which extend vertically along the bottom portion 128 of the side wall 120 and radially inward into the interior space inside the strainer 102. FIGS. 4 and 5 also illustrate that the intermediate portion 130 of the side wall 120 includes an opening 126, through which the pull-tab 116 of the seal 104 can extend.

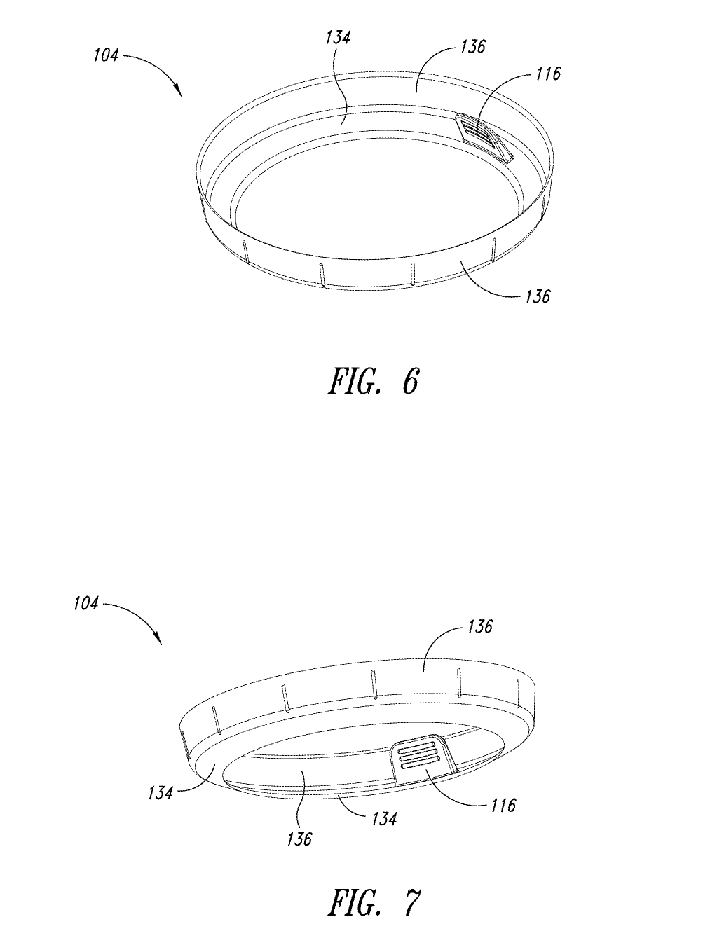

FIGS. 6 and 7 illustrate a top, perspective view and a bottom, perspective view, respectively, of the seal 104 of the food processor 100. As illustrated in FIGS. 6 and 7, the seal 104 includes a bottom, generally conical portion 134, and a top, generally cylindrical portion 136 coupled at a bottom end thereof to a top end of the bottom portion 134. The bottom portion 134 has an inner and upper surface that corresponds to, and is configured to mate and create a seal with, an outer and lower surface of the intermediate portion 130 of the side wall 120. Similarly, the top portion 136 has an inner surface that corresponds to, and is configured to mate and create a seal with, an outer surface of the top portion 132 of the side wall 120.

In some implementations, the inner and upper surface of the bottom portion 134 is smaller than (e.g., has a smaller diameter than) the outer and lower surface of the intermediate portion 130 of the side wall 120, and the inner surface of the top portion 136 is smaller than (e.g., has a smaller diameter than) the outer surface of the top portion 132 of the side wall 120. In such implementations, the seal 104 can be stretch-fit, or interference-fit over the respective outer surfaces of the strainer 102, to create a tight and secure fit between the seal 104 and the strainer 102. The pull tab 116 is coupled to and extends upward and inward away from the inner and upper surface of the bottom portion 134, and is sized to fit through the opening 126 in the intermediate portion 130 of the wide wall 120.

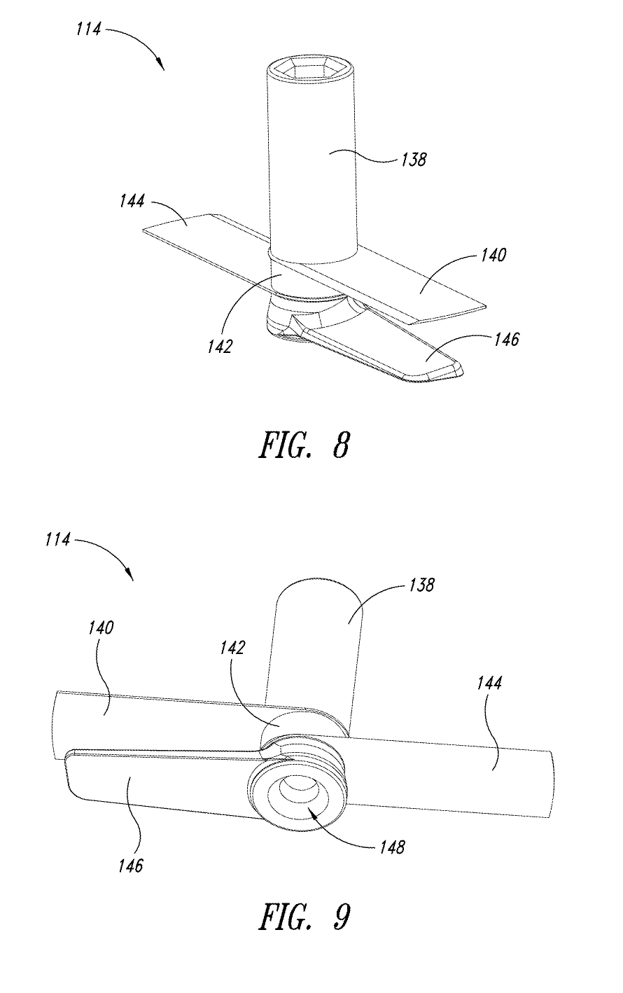

FIG. 8 illustrates a top, perspective view of the blade assembly 114 of the food processor 100. As illustrated in FIG. 8, the blade assembly 114 includes, from top to bottom, an outer spindle or shaft 138, a first blade 140, which can be made of metal, a blade spacer 142, a second blade 144, which can be made of metal, and an agitator 146. An outer surface of a top end of the outer shaft 138 can have a shape matching or corresponding to an inner surface of the inner cylindrical flange 112 of the lid 106. FIG. 9 illustrates a bottom, perspective view of the blade assembly 114. As illustrated in FIG. 9, the blade assembly 114 includes an indentation 148 that extends upward into the blade assembly 114 at a center portion of the bottom end of the blade assembly 114. The indentation 148 can have a shape matching or corresponding to the pin 122 formed at the center of the bottom wall 118 of the strainer 102.

Thus, when the blade assembly 114 is positioned within the strainer 102 and the lid 106 is positioned on top of the strainer 102, the blade assembly 114 can be seated on the bottom wall 118 of the strainer 102 such that the pin 122 is positioned within the indentation 148, and the lid 106 can be seated on the side wall 120 so that the top end of the blade assembly 114 is positioned within the inner cylindrical flange 112. Thus, together, the inner flange 112 and the pin 122 can secure the blade assembly 114 in place while the food processor 100 is in storage or otherwise not in use.

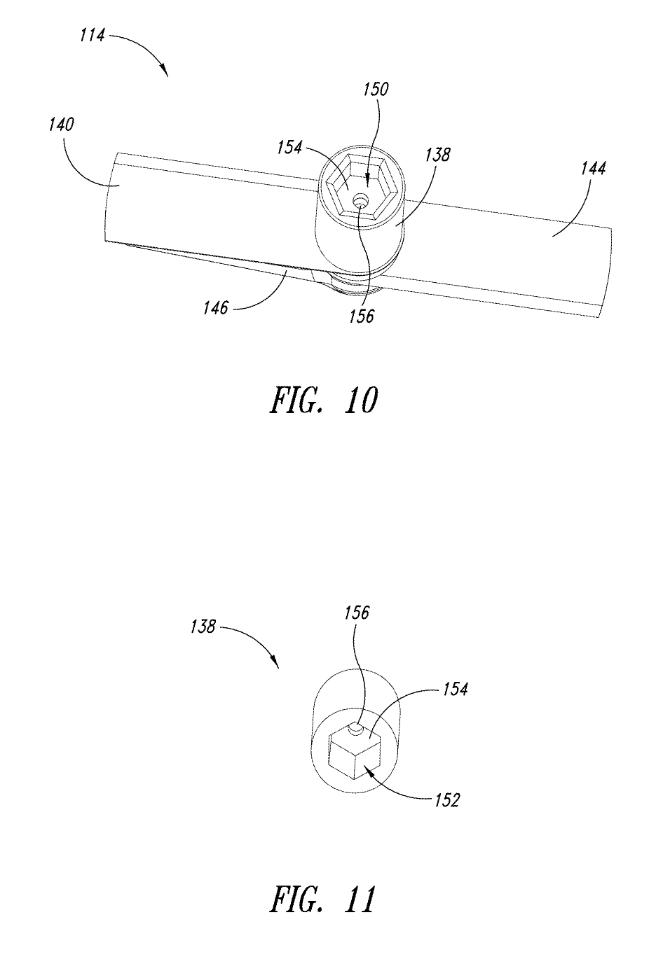

FIG. 10 illustrates another top, perspective view of the blade assembly 114 of the food processor 100. As illustrated in FIG. 10, a top end of the outer shaft 138 includes a counter-bored first recess 150, which can have a hexagonal cross-section shape. FIG. 11 illustrates a bottom, perspective view of the outer shaft 138. As illustrated in FIG. 11, a bottom end of the outer shaft 138 includes a second recess 152, which can have a hexagonal cross-section shape. FIGS. 10 and 11 also illustrate that the outer shaft 138 includes a dividing wall 154 that separates the first recess 150 from the second recess 152, and an aperture 156 that extends through the dividing wall 154 to couple the first recess 150 to the second recess 152.

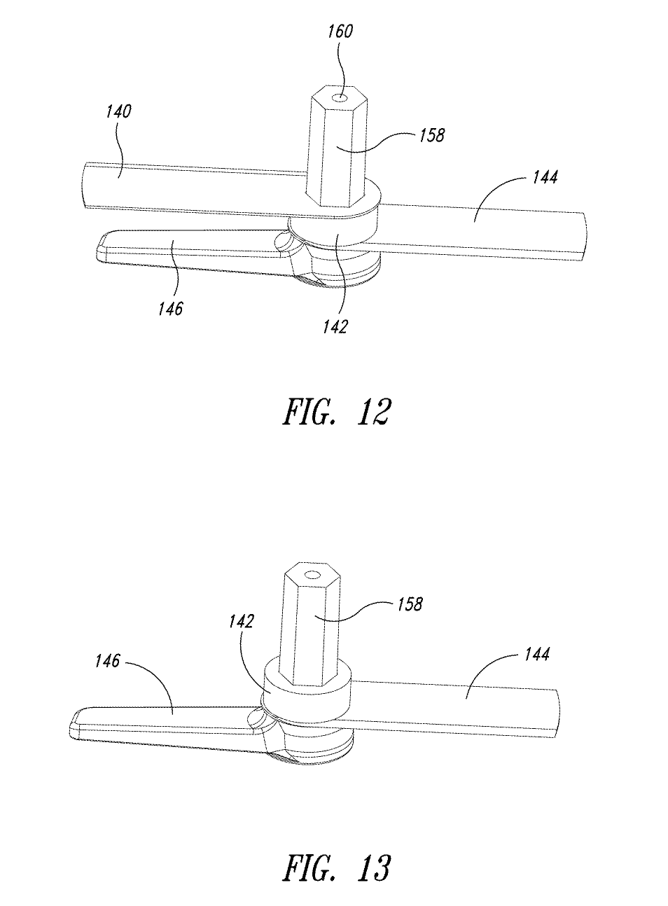

FIG. 12 illustrates a top, perspective view of the blade assembly 114 with the outer shaft 138 removed. As illustrated in FIG. 12, the blade assembly 114 includes an inner spindle or shaft 158, which can have a non-circular, or hexagonal cross-sectional shape that corresponds to or matches the cross-sectional shape of the second recess 152, and a threaded opening 160 that extends downward into the shaft 158 from a top end of the shaft 158. FIG. 13 illustrates the same top, perspective view of the blade assembly 114 as FIG. 12, but with the first blade 140 removed. As illustrated in FIGS. 12 and 13, the first blade 140 can include an opening at one end thereof, the opening having a shape corresponding to or matching the cross-sectional shape of the inner shaft 158, so that the inner shaft 158 can extend through the opening and so that the first blade 140 is thereby rotationally locked to the inner shaft 158.

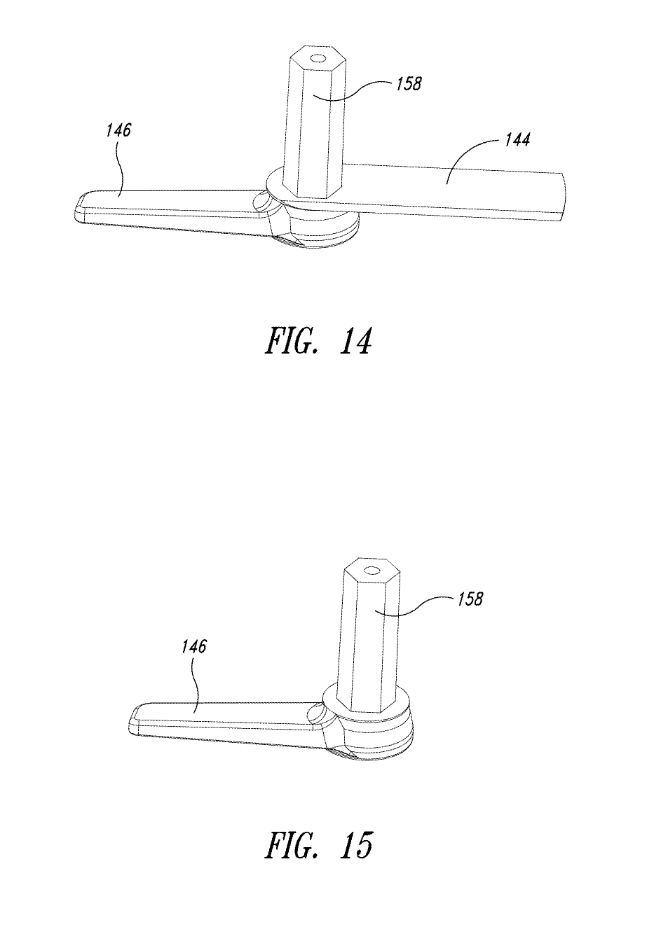

FIG. 14 illustrates the same top, perspective view of the blade assembly 114 as FIG. 13, but with the blade spacer 142 removed. As illustrated in FIGS. 13 and 14, the blade spacer 142 can include an opening having a shape corresponding to or matching the cross-sectional shape of the inner shaft 158, so that the inner shaft 158 can extend through the opening and so that the blade spacer 142 is thereby rotationally locked to the inner shaft 158. FIG. 15 illustrates the same top, perspective view of the blade assembly 114 as FIG. 14, but with the second blade 144 removed. As illustrated in FIGS. 14 and 15, the second blade 144 can include an opening at one end thereof, the opening having a shape corresponding to or matching the cross-sectional shape of the inner shaft 158, so that the inner shaft 158 can extend through the opening and so that the second blade 144 is thereby rotationally locked to the inner shaft 158. As also illustrated in FIG. 15, the agitator 146 is integrally formed with the inner shaft 158 so that the agitator 146 is rotationally locked to the inner shaft 158.

A method of using the food processor 100 can include assembling the blade assembly 114. For example, the blade assembly 114 can be assembled by first positioning the inner shaft 158 through the opening at the end of the second blade 144, to rotationally lock the second blade 144 to the inner shaft 158, then by positioning the inner shaft 158 through the opening at the center of the blade spacer 142, to rotationally lock the blade spacer 142 to the inner shaft 158, then by positioning the inner shaft 158 through the opening at the end of the first blade 140, to rotationally lock the first blade 140 to the inner shaft 158.

The blade assembly 114 can be further assembled by positioning the top end of the inner shaft 158 within the second recess 152 of the outer shaft 138, to rotationally lock the outer shaft 138 to the inner shaft 158, then by positioning a screw through the first recess 150, through the aperture 156, and into the threaded opening 160 in the top end of the inner shaft 158, and by screwing the screw down into the threaded opening 160 until the head of the screw is seated within the first recess 150 against the top surface of the dividing wall 154, thereby securing the outer shaft 138 to the inner shaft 158 and securing the first blade 140, spacer 142, and second blade 144 between the inner shaft 158 and the outer shaft 138.

The method of using the food processor 100 can also include coupling the seal 104 to the strainer 102, so that a seal is formed between the inner surfaces of the seal 104 and the outer surfaces of the strainer 102, and so that the pull-tab 116 of the seal 104 extends through the opening 126 in the side wall 120 of the strainer 102. The method can also include positioning the strainer 102 and the seal 104 on top of a container such as a bowl, a measuring cup, or a beaker, which will catch chopped materials as they fall through the holes 124 at the bottom of the strainer 102. In some cases, positioning the strainer 102 and the seal 104 on top of the container includes creating a seal between the seal 104 and the container, such as by seating either the bottom portion 134 or the top portion 136 of the seal 104 against a rim of the container.

The method can also include positioning the blade assembly 114 into the strainer 102 so that the pin 122 is positioned within the indentation 148, then positioning food items to be chopped, such as nuts, into the strainer 102 around the blade assembly 114. The strainer 102 can hold any desired number or amount of food items to be chopped, with ¼ cup, ½ cup, or between ¼ cup and ½ cup being examples. The method can also include positioning an actuator over the top of the strainer 102 and the blade assembly 114, so that the actuator is engaged with the first recess 150 at the top end of the blade assembly 114, such as by engaging a hexagonal driving member or bit of the actuator with the hexagonal first recess 150.

Any suitable actuator can be used with the food processor 100. For example, any device or method that can cause the blade assembly 114 to spin about the central longitudinal axes of the inner shaft 158 and the outer shaft 138 can be used. Examples of suitable actuators include electric motor-powered actuators and hand-powered actuators, including a vegetable chopper available from Taylor Precision Products, Inc., under the brand name VEGGICHOP, and those described in U.S. Pat. No. 7,264,189. In some cases, hand-powered actuators can be advantageous over electrically-powered actuators because they can more readily allow for real-time adjustment of the actuation based on the results of the chopping action (i.e., hand-powered actuation more readily allows for feedback from the results of the chopping to the actuation of the chopping). In some cases, such hand-powered or electric actuators can be commercially available in kits that include a container, which can be used to catch chopped food items as they fall through the holes 124 in the strainer 102. In some cases, such actuators can also act as a lid that covers the top of the strainer 102 while the food processor 100 is used to chop the food items.

The method can further include operating the actuator to drive rotation of the blade assembly 114, while the strainer 102, the seal 104, and the bowl underneath the food processor 100 remain stationary, to cut and/or chop the food items within the strainer 102. In some cases this can include turning a switch or a knob of an electrically-powered actuator. In other cases this can include pulling a cord, pushing a lever, or pushing a button of a hand-powered actuator. In some cases, this can include periodic, intermittent, or pulsing operation of the actuator. For example, periodic operation of an actuator operated by pulling a cord can be achieved by pulling the cord, thereby directly driving rotation of the blade assembly 114 for a first period of time, and then allowing the cord to retract, thereby not directly driving rotation of the blade assembly 114 for a second period of time, and then repeating as needed.

Operation of the actuator can directly drive rotation of the outer shaft 138, because the actuator is directly engaged with the first recess 150 of the outer shaft 138, and can drive rotation of the entire blade assembly 114, because the components of the blade assembly 114 are rotationally locked to one another. The blade assembly 114 can be mounted with the pin 122 seated within the indentation 148 and with the actuator seated within the first recess 150, to rotate about the central longitudinal axes of the outer shaft 138 and the inner shaft 158.

Rotation of the first and second blades 140, 144 can cause the food items such as nuts to be cut or chopped up into smaller pieces within the strainer 102. Once the food items have been chopped into sufficiently small pieces, the smaller pieces will fall through the holes 124 in the strainer 102 into the container below the strainer 102. In some cases, pieces of food that are too big to fall through the holes 124 may be caught by the holes 124 as they move around within the strainer 102, making it easier for the blades 140, 144 to further chop the pieces of food as the blades 140, 144 spin within the strainer 102. Further, the blade spacer 142 results in the blades 140, 144 being spaced apart from one another, so they can cut food items at different heights within the strainer 102, improving the chopping action of the food processor 100.

The agitator 146 can include a blunt blade (e.g., blunt with respect to the blades 140, 144) that pushes some pieces of chopped food through the holes 124 in the strainer 102, and that kicks up other pieces of food at the bottom of the strainer 102, to further improve the chopping action of the food processor 100 by reducing the amount of food that gets stuck below the first and second blades 140, 144. Further, the protrusions 125 can act to interrupt the motion of nuts or portions of nuts, or other food items around an outer portion of the interior space within the strainer 102, which can further improve the chopping action of the food processor 100 by reducing the amount of food that gets stuck radially outside the reach of the blade assembly 114. Further, the intermittent nature of the actuation of the blade assembly 114 can improve the chopping action of the food processor 100 by alternately chopping the food items, and then allowing a brief period of time for the chopped items to settle to the bottom of the strainer 102 and fall through the holes 124 into the container. In contrast, if the actuation of the blade assembly 114 is constant, then the chance that the food items become chopped to a greater degree than desired is increased, because the food items are unable to readily fall through the holes 124 once a desired size of the food items is reached.

Once the food processor has been used to chop the food items to a sufficient or desired degree, the actuator can be removed from the food processor 100, and the blade assembly 114 can be removed from the strainer 102. In some cases, the strainer 102 and the seal 104 can then be removed without any trouble from the container holding the chopped food items, while in other cases a seal that formed between the seal 104 and the rim of the container can resist removal of the seal 104 from the container. In the latter case, the pull-tab 116 can be pulled further through the opening 126 to initiate a separation of the seal 104 from the container, and the strainer 102 and the seal 104 can then be removed from the container. The chopped food items can then be eaten directly from the container or can be incorporated into other food items, such as baked goods, etc.

In some embodiments, the sizes of the holes 124 at the bottom of the strainer 102 can be adjustable. For example, the food processor 100 can be a kit including a plurality of different strainers 102, each of the strainers 102 having holes 124 of a different size. As another example, the food processor 100 can be a kit including a plurality of different meshes, each of the meshes having apertures of a different size and being configured to be positioned at the bottom of the strainer 102. As one further example, the food processor 100 can have two bottom walls 118, both of the bottom walls 118 having a plurality of holes 124 formed therethrough, and one of the bottom walls 118 being rotatable with respect to the other to change a size of an overlapping region of the holes 124 of the two bottom walls 118.

U.S. provisional patent application No. 62/514,665, filed Jun. 2, 2017, to which the present application claims priority, is hereby incorporated herein by reference in its entirety. The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A food processor comprising:
a strainer including a bottom wall having a plurality of holes and a side wall extending upward from an outer periphery of the bottom wall, the side wall having an opening and an outer surface; and
a sealing gasket extending circumferentially around the outer surface of the side wall, the sealing gasket having an inner surface sealed to the outer surface of the side wall of the strainer, the sealing gasket having a pull-tab extending through the opening in the side wall of the strainer.

2. The food processor of claim 1 wherein the strainer includes a pin extending upward from a center portion of the bottom wall, and the food processor further comprises a blade assembly having an indentation that extends upward into the blade assembly at a center portion of a bottom end of the blade assembly, the indentation having a shape corresponding to a shape of the pin.

3. The food processor of claim 1 wherein a bottom portion of the side wall of the strainer includes a plurality of protrusions spaced equally apart from one another about a central axis of the strainer, the protrusions extending radially inward into an interior of the strainer.

4. The food processor of claim 1 wherein the side wall of the strainer includes a bottom, vertical portion, an intermediate, conical portion, and a top, vertical portion.

5. The food processor of claim 4 wherein a bottom end of the intermediate, conical portion is coupled directly to a top end of the bottom, vertical portion and a bottom end of the top, vertical portion is coupled directly to a top end of the intermediate, conical portion.

6. The food processor of claim 5 wherein the bottom, vertical portion has a first inner diameter and the top, vertical portion has a second inner diameter that is larger than the first inner diameter.

7. The food processor of claim 6 wherein the sealing gasket includes a bottom conical portion and a top, cylindrical portion.

8. The food processor of claim 7 wherein a bottom end of the top, cylindrical portion of the sealing gasket is coupled directly to a top end of the bottom, conical portion.

9. The food processor of claim 8 wherein a bottom end of the bottom, conical portion has a third inner diameter and the top, cylindrical portion of the sealing gasket has a fourth inner diameter that is larger than the third inner diameter.

10. The food processor of claim 9 wherein an inner surface of the bottom, conical portion of the sealing gasket is sealed against an outer surface of the intermediate, conical portion of the side wall of the strainer.

11. The food processor of claim 10 wherein an inner surface of the top, cylindrical portion of the sealing gasket is sealed against an outer surface of the top, cylindrical portion of the side wall of the strainer.

12. A method of processing food, comprising:
coupling a gasket to a strainer so that a seal is formed between an inner surface of the gasket and an outer surface of the strainer and so that a pull-tab of the gasket extends through an opening in a side wall of the strainer into an interior of the strainer;
positioning the strainer and the seal on top of a container;
positioning a blade assembly inside the strainer;
positioning nuts inside the strainer around the blade assembly;
positioning an actuator on top of the strainer and the blade assembly; and
operating the actuator to drive rotation of the blade assembly.

13. The method of claim 12, further comprising pulling the pull tab through the opening toward the interior of the strainer.

14. The method of claim 12 wherein positioning the nuts inside the strainer includes positioning between ¼ cup and ½ cup of nuts inside the strainer.

15. The method of claim 12 wherein the actuator is hand-powered.

16. The method of claim 12 wherein operating the actuator includes operating the actuator to drive intermittent rotation of the blade assembly.

17. The method of claim 12 wherein the strainer includes a plurality of holes sized to allow ⅛ to ¼ of a peanut to fall through.
